(19) United States
(12) Patent Application Publication
(10) Pub. No.: US 2026/0087333 A1
(43) Pub. Date: Mar. 26, 2026

(54) ACCELERATED MODEL INFERENCE USING COMPRESSED MODEL WEIGHTS

(71) Applicant: Microsoft Technology Licensing, LLC, Redmond, WA (US)

(72) Inventors: Eric Chris Wolfgang SOMMERLADE, Oxford (GB); Karthik VIJAYAN, Reading (GB)

(73) Assignee: Microsoft Technology Licensing, LLC, Redmond, WA (US)

(21) Appl. No.: 18/937,802

(22) Filed: Nov. 5, 2024

Related U.S. Application Data
(60) Provisional application No. 63/699,640, filed on Sep. 26, 2024.

(51) Int. Cl. G06N 3/0495; G06N 3/082

(52) U.S. Cl. CPC G06N 3/0495; G06N 3/082

(57) ABSTRACT

Systems and methods for accelerated model inference are provided. In particular, a computing device may receive a prediction request from an application in a production environment, decompress a first set of compressed weights of a compressed model based on the prediction request, perform evaluation of the compressed model using the first set of decompressed weights while decompressing a next set of compressed weights of the compressed model, generate a prediction using the decompressed weights, and return the prediction to the application.

### CROSS-REFERENCE TO RELATED APPLICATIONS

This application claims priority to U.S. Provisional Patent Application 63/699,640, filed Sep. 26, 2024, which is hereby incorporated by reference in its entirety.

### BACKGROUND

Machine learning has witnessed a surge in interest in recent years, allowing many individuals and businesses to access powerful models with wide ranges of applications. However, these models usually require a large amount of parameters to be trained, and the size of these models has been growing rapidly thereby demands intensive computation, storage, and energy resources. Since many real-world applications demand real-time, on-device processing capabilities, model deployment and inference on resource-constrained devices (e.g., edge devices, mobile devices) become challenging.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In accordance with at least one example of the present disclosure, a method for accelerated model inference is provided. The method may include receiving, by a computing device, a prediction request in a production environment, decompressing, by the computing device, a first set of compressed weights of a compressed model based on the prediction request, wherein the compressed model is stored in a main memory of the computing device, performing, by the computing device, evaluation of the compressed model using the first set of decompressed weights while decompressing a next set of compressed weights of the compressed model, and generating, by the computing device, a prediction using the decompressed weights.

In accordance with at least one example of the present disclosure, a computing device for accelerated model inference for accelerated model inference is provided. The computing device comprising a processor and a memory having a plurality of instructions stored thereon that, when executed by the processor, causes the computing device to receive a prediction request from an application in a production environment, decompress a first set of compressed weights of a compressed model based on the prediction request, wherein the compressed model is stored in a main memory of the computing device, perform evaluation of the compressed model using the first set of decompressed weights while decompressing a next set of compressed weights of the compressed model, generate a prediction using the decompressed weights, and return the prediction to the application.

In accordance with at least one example of the present disclosure, a method for model compression is provided. The method may include generating a model, training the model to determine weights of the model for optimizing model outputs, performing quantization of the model to reduce a number of bits required to represent each weight of the model, and applying run-length encoding to the quantized weights to further compress the model.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 depicts a block diagram of an example of an operating environment for accelerating model inference may be implemented in accordance with examples of the present disclosure;

FIG. 2 depicts a block diagram of an example of an operating environment for accelerating model inference may be implemented in accordance with examples of the present disclosure;

FIG. 3 depicts a block diagram of an example of an operating environment in which a compressed model generator and a model inference manager may be implemented in accordance with examples of the present disclosure;

FIG. 4 depicts a flowchart of an example method for model compression in accordance with examples of the present disclosure;

FIGS. 5A and 5B depict a flowchart of an example method for accelerated model inference in accordance with examples of the present disclosure;

FIG. 6 is a block diagram illustrating example physical components of a computing device with which aspects of the disclosure may be practiced;

FIG. 7 is a simplified block diagram of a computing device with which aspects of the present disclosure may be practiced; and

FIG. 8 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Machine learning has witnessed a surge in interest in recent years, allowing many individuals and businesses to access powerful models with wide ranges of applications. However, these models usually require a large amount of parameters to be trained, and the size of these models has been growing rapidly thereby demands intensive computation, storage, and energy resources. Since many real-world applications demand real-time, on-device processing capabilities, model deployment and inference on resource-constrained devices (e.g., edge devices, mobile devices) become challenging.

In accordance with examples of the present disclosure, an accelerated model inference technique allows a computing device to execute and use a machine learning model for predictions in resource-constraint settings. To do so, a model is trained and compressed (e.g., via quantization and run-length encoding processes) on a server side and is transmitted to the computing device. Once the compressed model is in the production environment, the computing device may perform the accelerated model inference (i.e., real-time, on-device model inference). It should be appreciated that the production environment is an environment where the compressed model is deployed and used to make predictions or perform tasks on an inference device (e.g., a computing device 120). This technique allows the computing device to commence executing at least a portion of a compressed model without fully decompressing the entire compressed model and keeping the uncompressed model at full size before execution. More specifically, a portion of the compressed model (e.g., a first set of compressed weights of the compressed model) is decompressed and executed while another portion of the compressed model (e.g., a second set of decompressed weights of the compressed model) is being decompressed. In other words, the accelerate model inference technique allows the computing device to generate an output (e.g., a prediction) upon receiving an input (e.g., a prediction request) on-the-fly on its resource-constraint device.

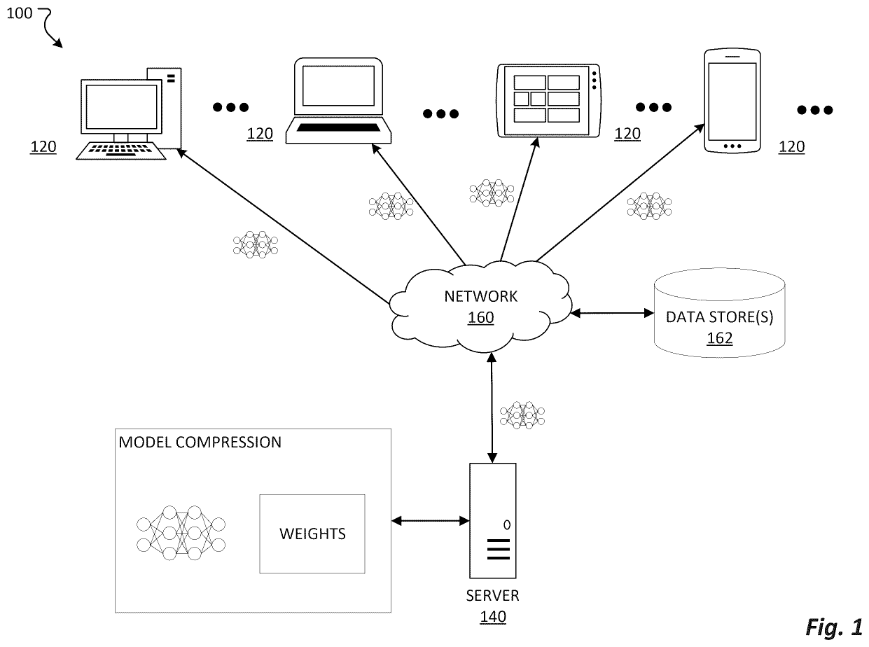

FIG. 1 depicts a block diagram of an example of an operating environment 100 for accelerating model inference in accordance with examples of the present disclosure. The operating environment 100 includes a plurality of computing devices 120 communicatively coupled to a server 140 via a network 160. As described further below, a model is trained and compressed at the server 140. It should be appreciated that the trained compressed model may be on the cloud server 140 and/or a data store 162 prior to the deployment. One or more compressed models are deployed to one or more computing devices 120. For example, a computing device 120 may request a model to be deployed and/or the server 140 may proactively deploy a compressed model to one or more computing devices 120 (e.g., based on resources and capabilities of computing devices).

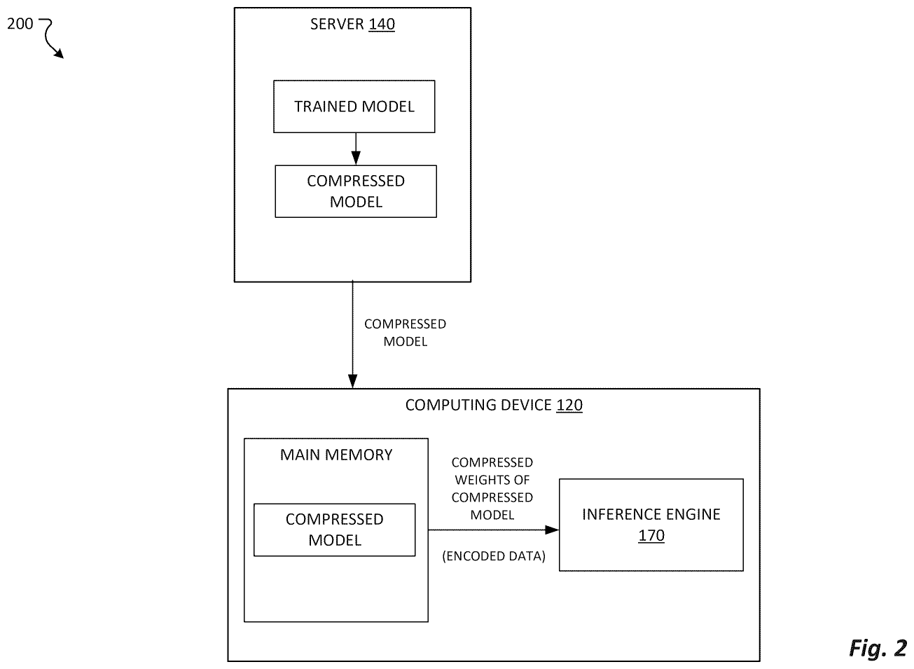

FIG. 2 depicts a block diagram of an example of an operating environment 200 for accelerating model inference in accordance with examples of the present disclosure. To do so, the operating environment 200 includes a server 140 and a computing device 120 associated a user 110. The server 140 is configured to generate and train a model. During the training of the model, the server 140 is configured to determine appropriate weight values of the model to optimize the model's output. The weights of the model are parameters that determine the strength and direction of the influence between layers in the model. For example, in neural networks, the weights are associated with connections between neurons or nodes of the model. The trained model is further compressed (e.g., via quantization and run-length encoding processes).

Once the compressed model is in the production environment, the computing device 120 may perform real-time, on-device model inferences, also referred to as an accelerated model inference technique. This technique allows the computing device 120 to execute and use a machine learning model for predictions in resource-constraint settings. As described further below, the computing device 120 commences executing at least a portion of a compressed model without fully decompressing the entire compressed model and keeping the uncompressed model at full size before execution. More specifically, a portion of the compressed model (e.g., a first set of compressed weights of the compressed model) is decompressed and executed while another portion of the compressed model (e.g., a second set of decompressed weights of the compressed model) is being decompressed. In other words, the accelerate model inference technique allows the computing device 120 to generate an output (e.g., a prediction) upon receiving an input (e.g., a prediction request) on-the-fly via an inference engine 170 on its resource-constraint device 120.

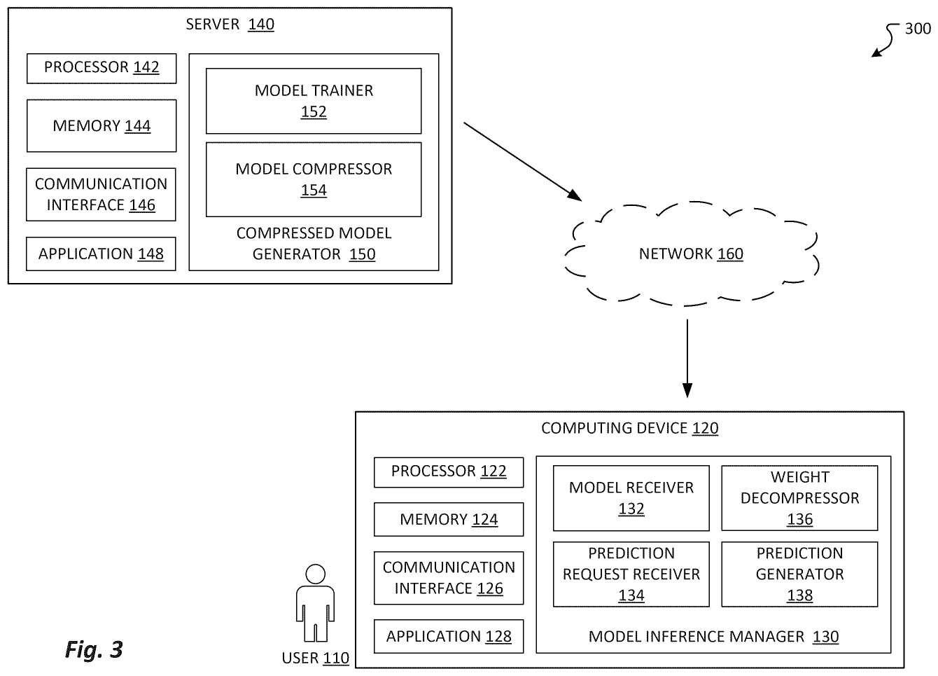

FIG. 3 depicts a block diagram of an example of an operating environment 300 in which a compressed model generator and a model inference manager may be implemented in accordance with examples of the present disclosure. To do so, the operating environment 300 includes a server 140 and a computing device 120 associated with a user 110. The server 140 may be any suitable computing device that is capable of executing the compressed model generator 150 and communicating with the computing devices 120 via a network 160. The computing device 120 may be, but is not limited to, a computer, a notebook, a laptop, a mobile device, a smartphone, a tablet, a portable device, a wearable device, or any other suitable computing device that is capable of executing the model inference manager 130. For example, the computing device 120 may be an edge device or a system-on-chip. The computing device 120 includes a processor 122 and a memory 124. The network 160 may include any kind of computing network including, without limitation, a wired or wireless local area network (LAN), a wired or wireless wide area network (WAN), and/or the Internet.

The compressed model generator 150 is configured to compress a machine learning model. To do so, the compressed model generator 150 further includes a model trainer 152 and a model compressor 154.

The model trainer 152 is configured to generate and train a model. During the training of the model, the model trainer 152 is configured to determine appropriate weight values of the model to optimize the model's output.

The model compressor 154 is configured to compress the model by quantization and run-length encoding processes. The model compressor 154 is configured to perform a quantization process by reducing a number of bits required to represent each weight of the model. The model compressor 154 is further configured to generates a mapping of initial weight values to the reduced bits (e.g., quantized weights) in a lookup table. It should be appreciated that the lookup table allows for fast compression/decompression in hardware or using SID intrinsic. For example, in deep neural networks (DNNs), weights may be stored as 32-bit floating point numbers. The model compressor 154 is configured to compress the initial network by reducing the number of bits required to represent each weight. For example, the weights may be quantized to 16-bit, 8-bit, 4-bit, and 1-bit. The lookup table may include indices, reduced bits (e.g., 2-bit representation), and values (e.g., 32-bit floating point numbers). By reducing the number of bits used, the size of the DNN can be significantly reduced. When a quantized model is deployed in a production environment (e.g., on a computing device 120), the quantized model executes some or all of the operations on tensors (e.g., weights) with integers rather than floating point values, which improves memory utilization and performance (e.g., faster vectorized operations).

The model compressor 154 is further configured to perform a run-length encoding (RLE) process to further compress the quantized weights. Run-length encoding (RLE) is a lossless compression method where sequences that display redundant data are stored as a single data value (e.g., a single occurrence of that data value and a count of its consecutive occurrences). In some embodiments, the model compressor 154 is further configured to find a permutation to optimize the run-length encoding. To do so, the model compressor 154 may be configured to shuffle or reorder inputs (e.g., quantized weights) to minimize an encoding dictionary and increase run length of indices. The encoding dictionary includes the indices that represent repeated values and are based on the strength of the compression, and the run length represents a number of consecutive repeated value. For example, stronger compression requires a fewer number of indices. For example, if there are 50% of 1s and 50% of 0s and an input vector is an alternate of 0s and 1s (e.g., 0101010101), the run length encoding will not be effective. In such an example, the model compressor 154 may be further configured to shuffle the input weight so that there are more consecutive 0s and 1s. In other words, the model compressor 154 is configured to find an optimal permutation of value of a matrix in front of the weight for a given tensor to optimize the run length encoding. The subsequent run-length encoding of the quantized model allows for a more compact model representation, thereby improving memory utilization and performance.

Additionally, the model compressor 154 is further configured to define and/or add a model description for a respective compressed model. The model description may include various parameters and attributes associated with the respective compressed model. For example, the model description may include how layers are connected (e.g., graphical information with nodes and connections between the nodes).

The computing device 120 is configured to communicate with the server 140 via the network 160 to receive one or more compressed machine learning models and dynamically perform accelerated model inferences on demand. The accelerated model inference technique allows real-time, on-device model inferences on resource-constrained computing devices 120. As described below, the computing device 120 is configured to commence executing at least a portion of a compressed model without fully decompressing the entire compressed model and keeping the uncompressed model at full size before execution. More specifically, a portion of the compressed model (e.g., a first set of compressed weights of the compressed model) that has been decompressed is being executed while another portion of the compressed model (e.g., a second set of decompressed weights of the compressed model) is being decompressed.

The model inference manager 130 is configured to perform accelerated model inferences. To do so, the model inference manager 130 further includes a model receiver 132, a prediction request receiver 134, a weight decompressor 136, and a prediction generator 138.

The model receiver 132 is configured to receive a compressed model on a computing device 120. For example, a compressed model may be received from the server 140 via the network 160. Additionally or alternatively, a compressed model may be directly transferred to the computing device 120 (e.g., system-on-chip). The model receiver 132 may further store the compressed model in a main memory of the computing device 120.

The prediction request receiver 134 is configured to receive a prediction request from an application 128 running on the computing device 120 in a production environment. The prediction request receiver 134 is further configured to select a machine learning model based on the prediction request (e.g., based on operations required by the prediction request). However, it should be appreciated that, in some embodiments, the prediction request receiver 134 may choose a variant of a machine learning model for a given use case.

The weight decompressor 136 is configured to extract compressed weights of the compressed model based on the prediction request and decompresses the compressed weights. For example, the weight decompressor 136 determines which portion or layer(s) of the compressed model (e.g., a set of compressed weights of the compressed model) to first extract and decompress based on a model description associated with the compressed model. For example, the model description may indicate a sequential order of which a set of compressed weights of the compressed model to be decompressed for execution. This allows the weight decompressor 136 to decompress only a portion of the compressed model and commence execution before decompressing the entire compressed model. This further allows the compressed model to be remained in the compressed form in the main memory during the model inference.

It should be appreciated that the compressed model weights are fetched and decompressed only when they are needed. This allows for a faster evaluation with far fewer multiplications (e.g., only number of values per bit representation less 1 for 0 values). This further reduces not only storage space, but also memory bandwidth requirements, which minimizes a bottleneck in large LLMs on both NPU and CPU.

The prediction generator 138 is configured to generate a prediction using the decompressed weights and return the prediction to the requesting application. For example, arithmetic operations of a typical machine learning model are performed using the decompressed weights to generate a prediction.

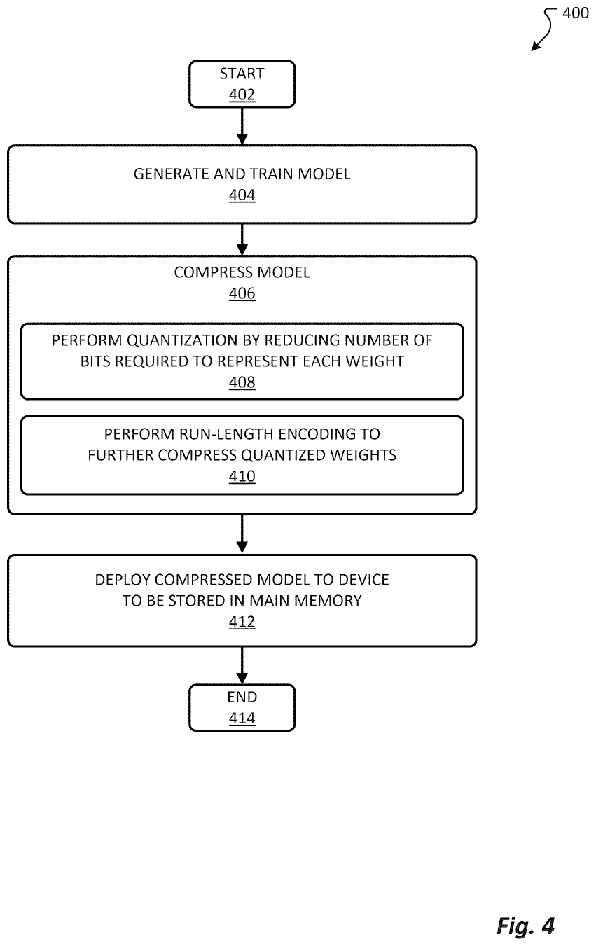

Referring now to FIG. 4, a method 400 for model compression in accordance with examples of the present disclosure is provided. A general order for the steps of the method 400 is shown in FIG. 4. Generally, the method 400 starts at 402 and ends at 414. The method 400 may include more or fewer steps or may arrange the order of the steps differently than those shown in FIG. 4. In the illustrative aspect, the method 400 is performed by a computing device (e.g., a server 140). However, it should be appreciated that one or more steps of the method 400 may be performed by another device (e.g., another server).

Specifically, in some aspects, the method 400 may be performed by a compressed model generator (e.g., 150) executed on the server 140. For example, the server 140 may be any suitable computing device that is capable of communicating with the computing device 120. For example, the computing device 120 may be, but is not limited to, a computer, a notebook, a laptop, a mobile device, a smartphone, a tablet, a portable device, a wearable device, or any other suitable computing device that is capable of communicating with the server 140. The method 400 can be executed as a set of computer-executable instructions executed by a computer system and encoded or stored on a computer readable medium. Further, the method 400 can be performed by gates or circuits associated with a processor, Application Specific Integrated Circuit (ASIC), a field programmable gate array (FPGA), a system on chip (SOC), a Neural Processing Unit (NPU), or other hardware device. Hereinafter, the method 400 shall be explained with reference to the systems, components, modules, software, data structures, user interfaces, etc. described in conjunction with FIGS. 1-3 and 6-9.

The method 400 starts at operation 402, where flow may proceed to 404. At operation 404, the compressed model generator 150 generates and trains a model (e.g., any deep neural network model, generative artificial intelligence model, large language model, or machine learning model). During the training of the model, appropriate weight values of the model are determined to optimize the model's output.

At operation 406, the compressed model generator 150 compresses the model. To do so, at operation 408, the compressed model generator 150 performs a quantization process by reducing a number of bits required to represent each weight of the model. The compressed model generator 150 further generates a mapping of initial weight values to the reduced bits (e.g., quantized weights) in a lookup table. It should be appreciated that the lookup table allows for fast compression/decompression in hardware or using SIMD intrinsic. For example, in deep neural networks (DNNs), weights may be stored as 32-bit floating point numbers. The compressed model generator 150 compresses the initial network by reducing the number of bits required to represent each weight. For example, the weights may be quantized to 16-bit, 8-bit, 4-bit, and 1-bit. The lookup table may include indices, reduced bits (e.g., 2-bit representation), and values (e.g., 32-bit floating point numbers). By reducing the number of bits used, the size of the DNN can be significantly reduced. While the method 400 described the post-training quantization, in some embodiments, quantization may be applied during training of the model (e.g., quantization aware training). In other words, when a quantized model is deployed in a production environment (e.g., on an inference device), the quantized model executes some or all of the operations on tensors (e.g., weights) with integers rather than floating point values, which improves memory utilization and performance (e.g., faster vectorized operations). Subsequently, at operation 410, the compressed model generator 150 performs a run-length encoding (RLE) process to further compress the quantized weights. Run-length encoding (RLE) is a lossless compression method where sequences that display redundant data are stored as a single data value (e.g., a single occurrence of that data value and a count of its consecutive occurrences). In some embodiments, the compressed model generator 150 may find a permutation to optimize the run-length encoding. To do so, the compressed model generator 150 may further shuffle or reorder inputs (e.g., quantized weights) to minimize an encoding dictionary and increase run length of indices. The encoding dictionary includes the indices that represent repeated values and are based on the strength of the compression, and the run length represents a number of consecutive repeated value. For example, stronger compression requires a fewer number of indices. For example, if there are 50% of 1s and 50% of 0s and an input vector is an alternate of 0s and 1s (e.g., 0101010101), the run length encoding will not be effective. In such an example, the compressed model generator 150 may shuffle the input weight so that there are more consecutive 0s and 1s. In other words, the compressed model generator 150 finds an optimal permutation of value of a matrix in front of the weight for a given tensor to optimize the run length encoding. The subsequent run-length encoding of the quantized model allows for a more compact model representation, thereby improving memory utilization and performance.

Additionally, the pressed model generator 150 further define and/or add a model description for the compressed model. The model description may include various parameters and attributes associated with the compressed model. For example, the model description may include how layers are connected (e.g., graphical information with nodes and connections between the nodes).

Once the model is compressed, at operation 412, the compressed model generator 150 deploys the compressed model (i.e., the quantized and encoded mode) to a computing device (e.g., 120) via a network (e.g., 160). However, it should be appreciated that, in some embodiments, the compressed model may be directly transferred to a system-on-chip. Subsequently, the method 400 may end at 414.

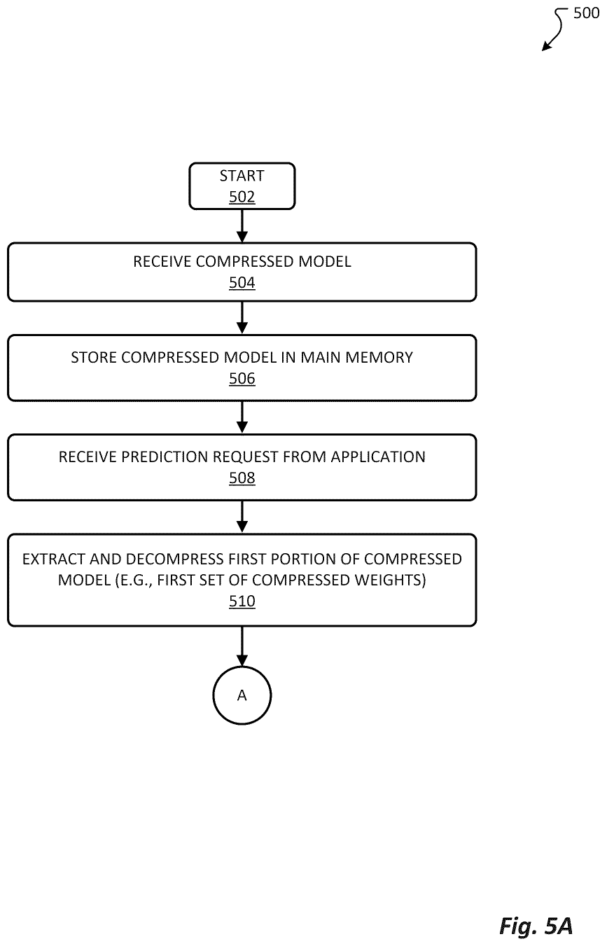

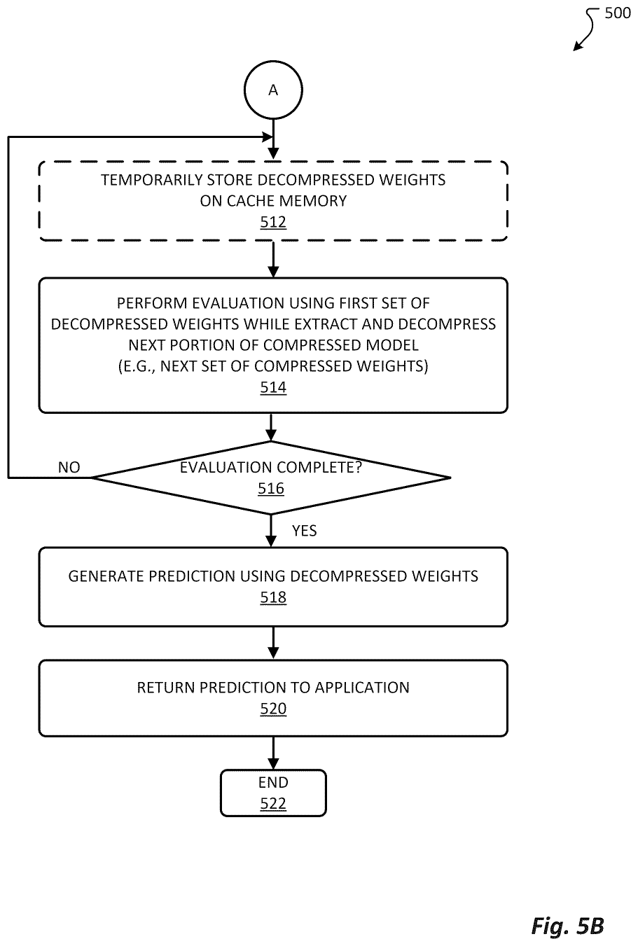

Referring now to FIGS. 5A and 5B, a method 500 for accelerated model inference in accordance with examples of the present disclosure is provided. A general order for the steps of the method 500 is shown in FIGS. 5A and 5B. Generally, the method 500 starts at 502 and ends at 522. The method 500 may include more or fewer steps or may arrange the order of the steps differently than those shown in FIGS. 5A and 5B. In the illustrative aspect, the method 500 is performed by a computing device 120 (e.g., an edge device or system-on-chip). However, it should be appreciated that one or more steps of the method 500 may be performed by another device.

Specifically, in some aspects, the method 500 may be performed by a model inference manager (e.g., 130) executed on the computing device 120. For example, the computing device 120 may be, but is not limited to, a computer, a notebook, a laptop, a mobile device, a smartphone, a tablet, a portable device, a wearable device, or any other suitable computing device that is capable of communicating with the server 140. For example, the server 140 may be any suitable computing device that is capable of communicating with the computing device 120. The method 500 can be executed as a set of computer-executable instructions executed by a computer system and encoded or stored on a computer readable medium. Further, the method 500 can be performed by gates or circuits associated with a processor, Application Specific Integrated Circuit (ASIC), a field programmable gate array (FPGA), a system on chip (SOC), a Neural Processing Unit (NPU), or other hardware device. Hereinafter, the method 500 shall be explained with reference to the systems, components, modules, software, data structures, user interfaces, etc. described in conjunction with FIGS. 1-3 and 6-8.

The method 500 starts at operation 502, where flow may proceed to 504. At operation 504, the model inference manager 130 receives a compressed model on the computing device 120. For example, the compressed model may be received from a server (e.g., 140) to an edge device (e.g., 120) via a network (e.g., 160). In some embodiments, the compressed model may be directly transferred to a system-on-chip (e.g., 120).

At operation 506, the model inference manager 130 stores the compressed model in a main memory of the computing device 120. As described further below, an accelerated model inference technique performed by the model inference manager 130 allows the compressed model to be remained in the compressed form in the main memory during the model inference. In other words, the compress model does not need to be fully decompressed into the decompressed form during the model inference. During the model inference, the model weights are decompressed on-the-fly on an inference device, such as a neural processing unit (NPU), of the computing device 120. However, it should be appreciated that the decompression may be performed on the central processing unit (CPU) (e.g. in SIMD opcodes) of the computing device 120.

At operation 508, the model inference manager 130 receives a prediction request from an application. In the illustrative embodiment, the model inference manager 130 selects a model based on the prediction request (e.g., based on operations required by the prediction request). However, it should be appreciated that, in some embodiments, the model inference manager 130 may choose a variant of a model for a given use case.

At operation 510, the model inference manager 130 extracts a first portion or layer(s) of the compressed model (e.g., a first set of compressed weights of the compressed model) based on the prediction request and decompresses the first set of compressed weights. For example, in the illustrative embodiment, a portion or layer(s) of the compressed model to be extracted and decompressed is determined and selected based on a model description associated with the compressed model. For example, the model description may indicate a sequential order of which a set of compressed weights of the compressed model to be decompressed for execution.

$$x = {w}^{T} X = {\sum }_{i} ( {w}_{i} {X}_{i} ) , x = {\sum }_{N} {w}_{N} ( {\sum }_{{k}_{N}} {X}_{{k}_{N}} )$$

Instead of calculating a dot product in the innermost calculation, the mathematically equivalent summation of input values and subsequent scaling are performed.

It should be appreciated that the compressed model weights are fetched and decompressed only when they are needed. This allows for a faster evaluation with far fewer multiplications (e.g., only number of values per bit representation less 1 for 0 values). This further reduces not only storage space, but also memory bandwidth requirements, which minimizes a bottleneck in large LLMs on both NPU and CPU.

In some embodiments, at operation 512, the model inference manager 130 may store the decompressed weights on a cache memory. In other words, the decompressed weights are temporarily stored so that it can be utilized for any subsequent computations. By retaining the model in the compressed form and decompressing only those required weights for prediction when needed, it allows the model inference manager 130 to enhance computational efficiency and performance while reducing storage resource consumption.

At operation 514, the model inference manager 130 performs evaluation using the first set of decompressed weights while extracting and decompressing a next portion of the compressed model (e.g., a next set of compressed weights of the compressed model). The model inference manager 130 determines the next set of compressed weights based on the model description associated with the compressed model. This accelerated model inference technique allows real-time, on-device model inferences on resource-constrained computing devices 120 on-the-fly by decompressing a portion of the compressed model and commencing execution before decompressing the entire compressed model. This further allows the compressed model to be remained in the compressed form in the main memory during the model inference.

At operation 516, the model inference manager 130 determines whether the evaluation of the model is complete. In other words, the model inference manager 130 determines whether execution of each portion of the compressed model has been completed. If not, the method 500 loops back to operations 512 and 514 to continue performing the evaluation, extracting, and decompressing steps until the accelerated model inference is complete and is ready to generate a prediction. If, however, the model inference manager 130 determines the evaluation of the model is complete at operation 516, the method 500 advances to operation 518.

At operation 518, the model inference manager 130 generates a prediction using the decompressed weights. For example, operations of a typical machine learning model are performed using the decompressed weights to generate a prediction. The simultaneous decompression and execution processes during the model inference result in dramatically fast evaluation to generate the prediction.

At operation 520, the model inference manager 130 returns the prediction to the application that requested the prediction request. The method 500 may end at 522.

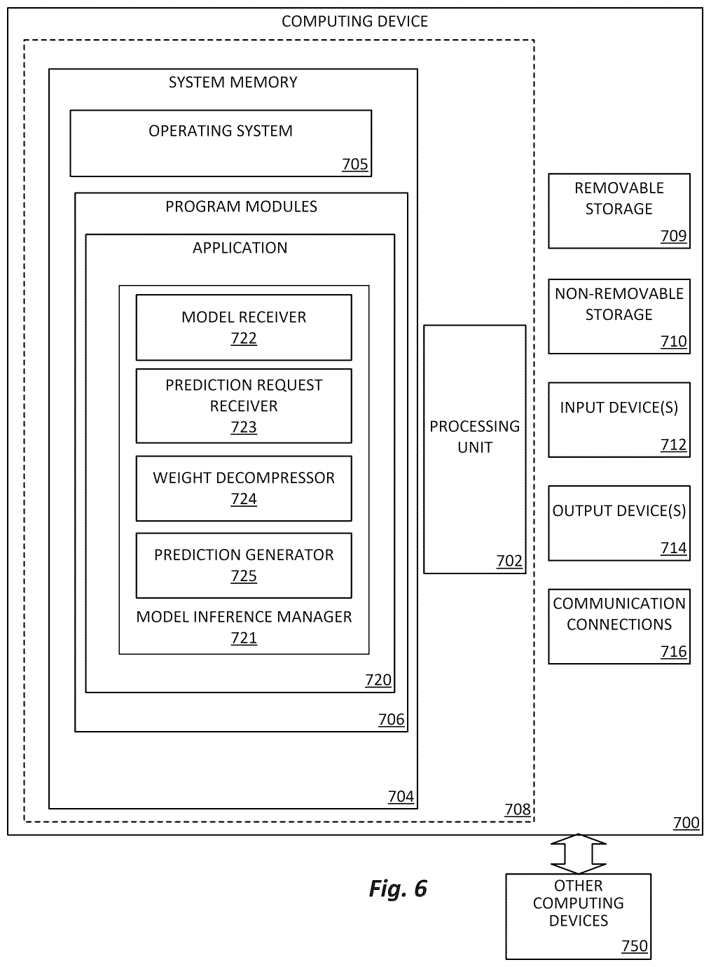

FIGS. 6-8 and the associated descriptions provide a discussion of a variety of operating environments in which aspects of the disclosure may be practiced. However, the devices and systems illustrated and discussed with respect to FIGS. 6-8 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 700 with which aspects of the disclosure may be practiced. The computing device components described below may be suitable for the computing devices described above, including one or more devices associated with machine learning service (e.g., server 140), as well as computing device 120 discussed above with respect to FIG. 2. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories.

The system memory 704 may include an operating system 705 and one or more program modules 706 suitable for running software application 720, such as one or more components supported by the systems described herein. As examples, system memory 704 may store a model inference manager 721, including a model receiver 722, a prediction request receiver 723, a weight decompressor 724, and/or a prediction generator 725. The operating system 705, for example, may be suitable for controlling the operation of the computing device 700.

Furthermore, aspects of the disclosure may be practiced in conjunction with a graphics library, other operating systems, or any other application program and is not limited to any particular application or system. This basic configuration is illustrated in FIG. 6 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 6 by a removable storage device 709 and a non-removable storage device 710.

As stated above, a number of program modules and data files may be stored in the system memory 704. While executing on the processing unit 702, the program modules 706 (e.g., application 720) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

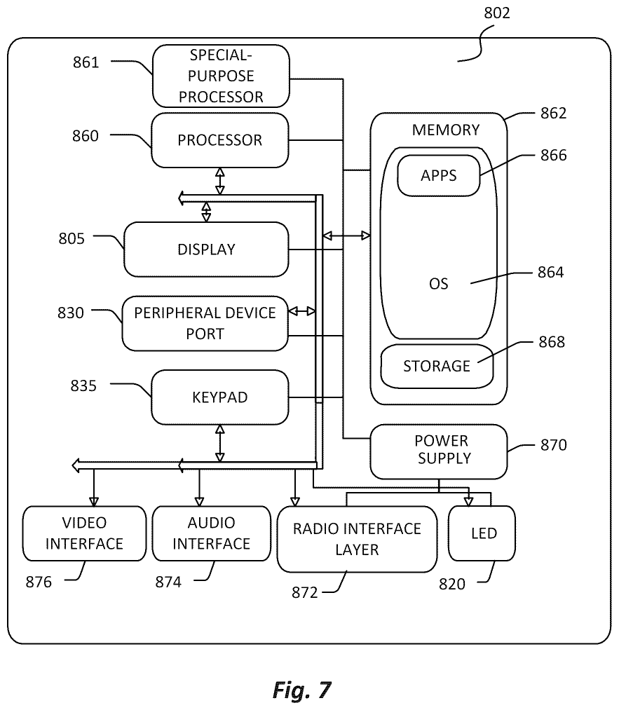

FIG. 7 illustrates a system 800 that may, for example, be a mobile computing device, such as a mobile telephone, a smart phone, wearable computer (such as a smart watch), a tablet computer, a laptop computer, and the like, with which aspects of the disclosure may be practiced. In one example, the system 800 is implemented as a “smart phone” capable of running one or more applications (e.g., browser, e-mail, calendaring, contact managers, messaging clients, games, and media clients/players). In some aspects, the system 800 is integrated as a computing device, such as an integrated personal digital assistant (PDA) and wireless phone.

In a basic configuration, such a mobile computing device is a handheld computer having both input elements and output elements. The system 800 typically includes a display 805 and one or more input buttons that allow the user to enter information into the system 800. The display 805 may also function as an input device (e.g., a touch screen display).

If included, an optional side input element allows further user input. For example, the side input element may be a rotary switch, a button, or any other type of manual input element. In alternative aspects, system 800 may incorporate more or less input elements. For example, the display 805 may not be a touch screen in some aspects. In another example, an optional keypad 835 may also be included, which may be a physical keypad or a “soft” keypad generated on the touch screen display.

In various aspects, the output elements include the display 805 for showing a graphical user interface (GUI), a visual indicator 820 (e.g., a light emitting diode), and/or an audio transducer 825 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 800 also includes a non-volatile storage area 868 within the memory 862. The non-volatile storage area 868 may be used to store persistent information that should not be lost if the system 800 is powered down. The application programs 866 may use and store information in the non-volatile storage area 868, such as e-mail or other messages used by an e-mail application, and the like. A synchronization application (not shown) also resides on the system 800 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the system 800 described herein (e.g., a content capture manager, a content transformer, etc.).

The system 800 has a power supply 870, which may be implemented as one or more batteries. The power supply 870 might further include an external power source, such as an AC adapter or a powered docking cradle that supplements or recharges the batteries.

The system 800 may also include a radio interface layer 872 that performs the function of transmitting and receiving radio frequency communications. The radio interface layer 872 facilitates wireless connectivity between the system 800 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via the audio transducer 825. In the illustrated example, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with aspects of the present disclosure, the microphone may also serve as an audio sensor to facilitate control of notifications, as will be described below. The system 800 may further include a video interface 876 that enables an operation of an on-board camera 830 to record still images, video stream, and the like.

It will be appreciated that system 800 may have additional features or functionality. For example, system 800 may also include additional data storage devices (removable and/or non-removable) such as, magnetic disks, optical disks, or tape. Such additional storage is illustrated in FIG. 7 by the non-volatile storage area 868.

Data/information generated or captured and stored via the system 800 may be stored locally, as described above, or the data may be stored on any number of storage media that may be accessed by the device via the radio interface layer 872 or via a wired connection between the system 800 and a separate computing device associated with the system 800, for example, a server computer in a distributed computing network, such as the Internet. As should be appreciated, such data/information may be accessed via the radio interface layer 872 or via a distributed computing network. Similarly, such data/information may be readily transferred between computing devices for storage and use according to any of a variety of data/information transfer and storage means, including electronic mail and collaborative data/information sharing systems.

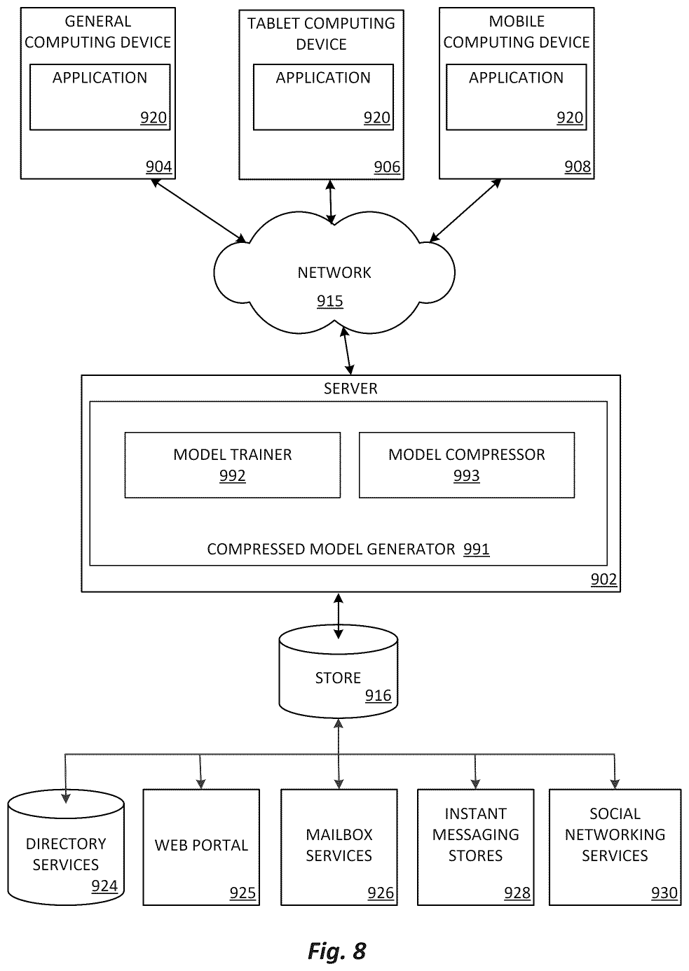

FIG. 8 illustrates one aspect of the architecture of a system for processing data received at a computing system from a remote source, such as a personal computer 904, tablet computing device 906, or mobile computing device 908, as described above. Content displayed at server device 902 may be stored in different communication channels or other storage types. For example, various documents may be stored using a directory service 924, a web portal 925, a mailbox service 926, an instant messaging store 928, or a social networking site 930.

An application 920 (e.g., similar to the application 720) may be employed by a client that communicates with server device 902. Additionally, or alternatively, a compressed model generator 991 may be employed by server device 902. The compressed model generator 991 may further include a model trainer 992 and a model compressor 993, which may be employed by the server device 902. The server device 902 may provide data to and from a client computing device such as a personal computer 904, a tablet computing device 906 and/or a mobile computing device 908 (e.g., a smart phone) through a network 915. By way of example, the computer system described above may be embodied in a personal computer 904, a tablet computing device 906 and/or a mobile computing device 908 (e.g., a smart phone). Any of these examples of the computing devices may obtain content from the store 916, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The example systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the example aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Example hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

In accordance with at least one example of the present disclosure, a method for accelerated model inference is provided. The method may include receiving, by a computing device, a prediction request in a production environment, decompressing, by the computing device, a first set of compressed weights of a compressed model based on the prediction request, wherein the compressed model is stored in a main memory of the computing device, performing, by the computing device, evaluation of the compressed model using the first set of decompressed weights while decompressing a next set of compressed weights of the compressed model, and generating, by the computing device, a prediction using the decompressed weights.

In accordance with at least one example of the present disclosure, a computing device for accelerated model inference for accelerated model inference is provided. The computing device comprising a processor and a memory having a plurality of instructions stored thereon that, when executed by the processor, causes the computing device to receive a prediction request from an application in a production environment, decompress a first set of compressed weights of a compressed model based on the prediction request, wherein the compressed model is stored in a main memory of the computing device, perform evaluation of the compressed model using the first set of decompressed weights while decompressing a next set of compressed weights of the compressed model, generate a prediction using the decompressed weights, and return the prediction to the application.

In accordance with at least one example of the present disclosure, a method for model compression is provided. The method may include generating a model, training the model to determine weights of the model for optimizing model outputs, performing quantization of the model to reduce a number of bits required to represent each weight of the model, and applying run-length encoding to the quantized weights to further compress the model.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

What is claimed is:

1. A method for accelerated model inference, the method comprising:
receiving, by a computing device, a prediction request from an application in a production environment;
decompressing, by the computing device, a first set of compressed weights of a compressed model based on the prediction request;
performing, by the computing device, evaluation of the compressed model using the first set of decompressed weights while decompressing a next set of compressed weights of the compressed model;
generating, by the computing device, a prediction using the decompressed weights; and
returning, by the computing device, the prediction to the application.

2. The method of claim 1, further comprising:
receiving, by the computing device, a compressed model from a server, wherein the compressed model includes a model description including one or more parameters and attributes associated with the compressed model.

3. The method of claim 2, wherein the one or more parameters and attributes indicate how nodes or layers of the model are connected and a sequential order of which a set of compressed weights of the compressed model to be decompressed for execution.

4. The method of claim 3, wherein the decompressing the first set of compressed weights of the compressed based on the prediction request comprises:
extracting and decompressing, by the computing device, a portion of the compressed model based on the prediction request and the model description, wherein the portion of the compressed model defined by the first set of decompressed weights.

5. The method of claim 3, wherein the next set of compressed weights of the compressed model is determined based on the model description associated with the compressed model.

6. The method of claim 1, further comprising:
storing, by the computing device, the first set and/or the next set of decompressed weights on a cache memory.

7. The method of claim 1, wherein the compressed model is stored in a compressed form in a main memory of the computing device during the accelerated model inference.

8. The method of claim 1, wherein performing the evaluation of the compressed model comprises:
performing summation and scaling of the first set of decompressed weights that is mathematically equivalent to an innermost calculation of a dot product during a convolution operation.

9. A computing device for accelerated model inference, the computing device comprising:
a processor; and
a memory having a plurality of instructions stored thereon that, when executed by the processor, causes the computing device to:
receive a prediction request from an application in a production environment;
decompress a first set of compressed weights of a compressed model based on the prediction request;
perform evaluation of the compressed model using the first set of decompressed weights while decompressing a next set of compressed weights of the compressed model;
generate a prediction using the decompressed weights; and
return the prediction to the application.

10. The computing device of claim 9, wherein the plurality of instructions, when executed, further cause the computing device to:
receive a compressed model from a server, wherein the compressed model includes a model description including one or more parameters and attributes associated with the compressed model.

11. The computing device of claim 10, wherein the one or more parameters and attributes indicate how nodes or layers of the model are connected and a sequential order of which a set of compressed weights of the compressed model to be decompressed for execution.

12. The computing device of claim 11, wherein the decompressing the first set of compressed weights of the compressed based on the prediction request comprises:
extracting and decompressing, by the computing device, a portion of the compressed model based on the prediction request and the model description, wherein the portion of the compressed model defined by the first set of decompressed weights.

13. The computing device of claim 11, wherein the next set of compressed weights of the compressed model is determined based on the model description associated with the compressed model.

14. The computing device of claim 9, wherein the plurality of instructions, when executed, further cause the computing device to store the first set and/or the next set of decompressed weights on a cache memory.

15. The computing device of claim 9, wherein the compressed model is stored in a compressed form in a main memory of the computing device during the accelerated model inference.

16. The computing device of claim 9, wherein to perform the evaluation of the compressed model comprises to:
perform summation and scaling of the first set of decompressed weights that is mathematically equivalent to an innermost calculation of a dot product during a convolution operation.

17. A method for model compression, the method comprising:
generating a model;
training the model to determine weights of the model for optimizing model outputs;
performing quantization of the model to reduce a number of bits required to represent each weight of the model; and
applying run-length encoding to the quantized weights to further compress the model.

18. The method of claim 17, further comprising:
defining a model description associated with the model, the model description including one or more parameters and attributes associated with the compressed model.

19. The method of claim 18, wherein the one or more parameters and attributes indicate how nodes or layers of the model are connected.

20. The method of claim 17, further comprising shuffling the quantized weights to minimize an encoding dictionary and increase run length of indices.
